(19) United States
(12) Patent Application Publication
(10) Pub. No.: US 2019/0246104 A1
(43) Pub. Date: Aug. 8, 2019

(54) PANORAMIC VIDEO PROCESSING METHOD, DEVICE AND SYSTEM

(71) Applicant: AUTEL ROBOTICS CO., LTD., Shenzhen (CN)

(72) Inventor: Yang LIU, Shenzhen (CN)

(21) Appl. No.: 16/389,556

(22) Filed: Apr. 19, 2019

Related U.S. Application Data
(63) Continuation of application No. PCT/CN2017/107376, filed on Oct. 23, 2017.

(30) Foreign Application Priority Data
Oct. 26, 2016 (CN) 201610952287.7

(51) Int. Cl. H04N 19/115; H04N 19/167; H04N 19/164; H04N 19/146

(52) U.S. Cl. CPC H04N 19/115; H04N 19/146; H04N 19/164; H04N 19/167

(57) ABSTRACT

Implementations of the present application provide a panoramic video processing method, device and system. A terminal device receives a partition parameter sent by a display device, then determines a first video area and a second video area in a panoramic video picture according to the partition parameter, processes video data in the first video area at a first bit rate, and processes video data in the second video area at a second bit rate. In this way, an image corresponding to a user observation area is processed at a high bit rate, and an image corresponding to a user non-observation area is processed at a low bit rate, thereby ensuring that timeliness of image transmission between the display device and the terminal device, clarity of a video image viewed by a user, and user experience are improved in a case of a limited channel bandwidth.

### CROSS REFERENCE

The present application is a continuation of International Application NO. PCT/CN2017/107376, filed on Oct. 23, 2017, which claims priority to Chinese Patent Application No. 201610952287.7, filed on Oct. 26, 2016 and entitled “PANORAMIC VIDEO PROCESSING METHOD, DEVICE AND SYSTEM”, both of which are incorporated herein by reference in their entireties.

### TECHNICAL FIELD

The present application relates to the field of panoramic image processing ologies, and in particular, to a panoramic video processing method, device and system.

### RELATED ART

With the popularity of VR head-mounted display devices and aerial vehicles, a panoramic camera module carried in an aerial vehicle captures a large range of image information in a high-altitude scene, and then sends the image information to a VR head-mounted display device by using a wireless transmission technology such as Wi-Fi, Bluetooth, ZigBee, or mobile communication. In the prior art, images of various angles captured by the panoramic camera module are usually stitched to form an image frame, and then the image frame is mapped to a spherical shell of a built virtual sphere model, to obtain a spherical image shown by the sphere model. Wearing a VR head-mounted display device to view a panoramic view of the spherical image improves user experience and immersion.

It is found by the inventor in the process of implementing the present application that, in view of a limited channel bandwidth in a current wireless transmission technology, it is difficult to display the spherical image in real time by using a VR head-mounted display device in the process of sending the image frame to the VR head-mounted display device. Although it is possible to adapt to a limited channel bandwidth by reducing bit rate and reducing frame rate to improve timeliness, the quality of a video image viewed on the VR head-mounted display device has been sacrificed and the user experience is degraded.

### SUMMARY

The technical problem to be mainly resolved by implementations of the present application is to provide a panoramic video processing method, device and system, to ensure that timeliness of image transmission between a display device and a terminal device and clarity of a video image viewed by a user are improved in a case of a limited channel bandwidth.

According to a first aspect, an embodiment of the present application provides a panoramic video processing method, including:

receiving a partition parameter sent by a display device;

determining a first video area and a second video area in a panoramic video picture according to the partition parameter; and

processing video data in the first video area at a first bit rate, and processing video data in the second video area at a second bit rate.

According to a second aspect, an embodiment of the present application provides a panoramic video processing device, the device including:

a parameter receiving module, configured to receive a partition parameter sent by a display device;

an area determining module, configured to determine a first video area and a second video area in a panoramic video picture according to the partition parameter;

a first bit rate processing module, configured to process video data in the first video area at a first bit rate; and

a second bit rate processing module, configured to process video data in the second video area at a second bit rate.

According to a third aspect, an embodiment of the present application provides a panoramic video processing method, the method including:

sending a partition parameter to a terminal device; and

receiving a panoramic video picture fed back by the terminal device according to the partition parameter, the panoramic video picture including a first video area and a second video area, video data in the first video area being processed at a first bit rate, and video data in the second video area being processed at a second bit rate.

According to a fourth aspect, an embodiment of the present application provides a panoramic video processing device, the device including:

a parameter sending module, configured to send a partition parameter to a terminal device; and

a picture receiving module, configured to receive a panoramic video picture fed back by the terminal device according to the partition parameter, the panoramic video picture comprising a first video area and a second video area, video data in the first video area being processed at a first bit rate, and video data in the second video area being processed at a second bit rate.

According to a fifth aspect, an embodiment of the present application provides a panoramic video processing system, the system including:

a display device, configured to send a partition parameter to the terminal device; and

a terminal device, configured to: determine a first video area and a second video area in a panoramic video picture according to the partition parameter, process video data in the first video area at a first bit rate, and process video data in the second video area at a second bit rate.

According to a sixth aspect, an embodiment of the present application provides a computer readable storage medium, storing a computer program, where the computer program, when executed by a processor, implements the steps of the foregoing panoramic video processing method.

The embodiments of the present application provide a panoramic video processing method, device and system. A terminal device receives a partition parameter sent by a display device, then determines a first video area and a second video area in a panoramic video picture according to the partition parameter, processes video data in the first video area at a first bit rate, and processes video data in the second video area at a second bit rate. In this way, an image corresponding to a user observation area is processed at a high bit rate, and an image corresponding to a user non-observation area is processed at a low bit rate, thereby ensuring that timeliness of image transmission between the display device and the terminal device, clarity of a video image viewed by a user, and user experience are improved in a case of a limited channel bandwidth.

### BRIEF DESCRIPTION OF THE DRAWINGS

To describe the technical solutions of the embodiments of the present application more clearly, the accompanying drawings required for the embodiments of the present application are briefly described below. Apparently, the accompanying drawings in the following description merely show some embodiments of the present application, and a person of ordinary skill in the art can derive other drawings from these accompanying drawings without creative efforts.

FIG. 1 is a flowchart of a panoramic video processing method according to an embodiment of the present application;

FIG. 2a and FIG. 2b are schematic diagrams showing that an orientation of a user perspective switches within a sphere model;

FIG. 3a and FIG. 3b are schematic diagrams of the range of a user perspective corresponding to the changes of an image in a panoramic video picture;

FIG. 4 is a functional block diagram of a panoramic video processing device according to an embodiment of the present application;

FIG. 5 is a functional block diagram of a panoramic video processing device according to another embodiment of the present application;

FIG. 6 is a flowchart of a panoramic video processing method according to an embodiment of the present application;

FIG. 7 is a functional block diagram of a panoramic video processing device according to an embodiment of the present application;

FIG. 8 is a functional block diagram of a panoramic video processing device according to another embodiment of the present application; and

FIG. 9 is a schematic diagram of a panoramic video processing system according to an embodiment of the present application.

### DETAILED DESCRIPTION

To make the objectives, technical solutions, and advantages of the present application clearer and more comprehensible, the following further describes the present application in detail with reference to the accompanying drawings and embodiments. It should be understood that the specific embodiments described herein are merely used for explanation of the present application but are not intended to limit the present application.

In addition, the technical features involved in the implementations of the present application described below may be combined with each other as long as they do not constitute a conflict with each other.

A panoramic video processing method of the embodiments of the present application may be based on an information interaction process between a terminal device and a display device that are in communication connection with a panoramic camera module. The panoramic camera module may include one or more cameras. The terminal device may be an aerial vehicle, a camera, a mobile phone, a tablet computer, or the like. The display device may be a VR head-mounted display device, a television, a projection device, or the like. The terminal device performs preset processing on a panoramic video captured by the panoramic camera module, and then sends, in a wireless or wired transmission manner, the processed panoramic video to the display device for display. The wireless transmission manner includes but is not limited to wireless transmission technologies such as Wi-Fi, Bluetooth, ZigBee and mobile data communication.

The following specifically elaborates the embodiments of the present application with reference to the specific accompanying drawings.

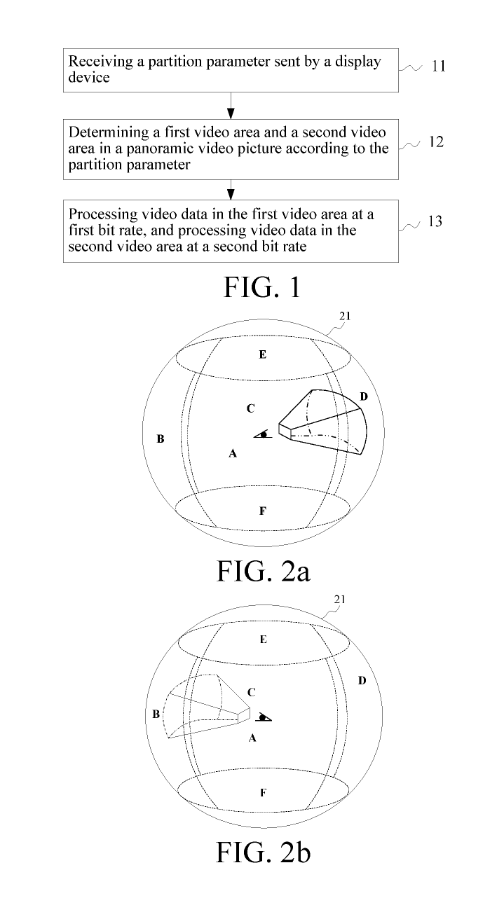

As shown in FIG. 1, an embodiment of the present application provides a panoramic video processing method. The method may be performed by a terminal device, The method includes:

Step 11: receiving a partition parameter sent by a display device.

In this embodiment of the present application, take as an example the display device being a VR head-mounted display device. A panoramic camera module photographs a panoramic video picture. The terminal device feeds back the panoramic video picture to the VR head-mounted display device according to a partition parameter sent by the VR head-mounted display device.

When the VR head-mounted display device is worn by a user, in order that a three-dimensional effect of the panoramic video picture can be viewed, as shown in FIG. 2a, the VR head-mounted display device may build a sphere model 21 in a virtual three-dimensional space, and then map the panoramic video picture to a spherical shell of the sphere model 21, to obtain a spherical video picture shown by the sphere model 21. In this way, a two-dimensional panoramic video picture is simulated into a three-dimensional spherical video picture for presentation to the user.

Switching of a user perspective can implement presentation of different areas in the spherical video picture to the user. The implementation of the switching of the user perspective includes but is not limited to the following two manners:

In a first manner, the user wearing the VR head-mounted display device rotates his head, and a gyroscope of the VR head-mounted display device detects the rotation of the user's head and determines an orientation of the user perspective, so as to present an area, to which the user perspective is oriented, in the spherical video picture to the user. For example, an area to which the user perspective is oriented shown in FIG. 2a is switched to an area to which the user perspective is oriented shown in FIG. 2b.

In a second manner, the user wearing the VR head-mounted display device operates a joystick or a button on a remote control, and the VR head-mounted display device can present different areas in the spherical video picture to the user according to swinging by the joystick or triggering by the button. The remote control may communicate with the VR head-mounted display device in a wireless or wired transmission manner.

It should be noted that in the implementation of the switching of the user perspective, the first manner may be adopted, or the second manner may be adopted, or switching between the first manner and the second manner may be adopted, so that the user may select the first manner or the second manner.

In this embodiment of the present application, the spherical shell of the sphere model may be divided into multiple partitions. A quantity of the partitions and an area size of each partition may be adaptively adjusted based on a view angle of a display screen of the display device. For example, in FIG. 2a and FIG. 2b, the spherical shell of the sphere model 21 is divided into six partitions including a partition A, a partition B, a partition C, a partition D, a partition E and a partition F. One partition may be used to correspondingly preset a picture of an area photographed by one camera in the panoramic camera module. At a fixed moment, a range of the user perspective can involve one to three partitions, and positions of the partitions involved by the range of the user perspective can be calculated according to an orientation of the user perspective, so that numbers of the involved partitions can be determined.

Step 12: determining a first video area and a second video area in a panoramic video picture according to the partition parameter.

As an optional implementation, the partition parameter may be positions of partitions of the panoramic video picture determined according to the user perspective of the display device. As shown in FIG. 2a, the range of the user perspective involves two areas, namely, the partition C and the partition D, After the switching of the user perspective, as shown in FIG. 2b, the range of the user perspective involves two areas, namely, the partition B and the partition C.

As an optional implementation, the partition parameter includes first identification information and second identification information. A step of determining the partition parameter specifically includes:

obtaining, in the spherical video picture, first identification information of an image corresponding to the first video area and second identification information of an image corresponding to the second video area; and

integrating the first identification information and the second identification information into the partition parameter.

In this optional implementation, the image that is in the spherical video picture and that corresponds to the first video area in the panoramic video picture has the first identification information, and the image that is in the spherical video picture and that corresponds to the second video area in the panoramic video picture has the second identification information, so that the first video area and the second video area in the panoramic video picture can be determined by using the first identification information and the second identification information.

Step 13: processing video data in the first video area at a first bit rate, and processing video data in the second video area at a second bit rate.

In an embodiment, compression coding is performed at the first bit rate and the second bit rate on all video data that is in the panoramic video picture and that corresponds to different partitions. That is, compression coding is performed on video data corresponding to each partition at both the first bit rate and the second bit rate. However, in a video data sending phase, video data on which the compression coding is performed at a corresponding bit rate is sent for different video areas according to the partition parameter.

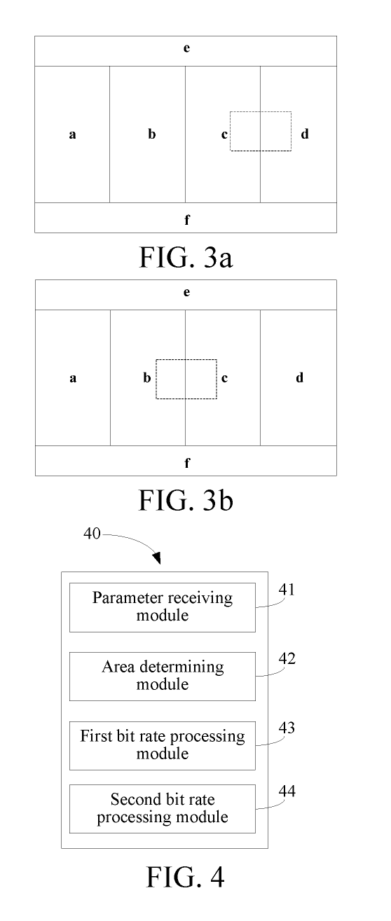

FIG. 3a is a schematic diagram of images in the panoramic video picture that correspond to the range of the user perspective in FIG. 2a. FIG. 3b is a schematic diagram of images in the panoramic video picture that correspond to the user perspective in FIG. 2b.

In this embodiment of the present application, the images in the panoramic video picture include an image a, an image b, an image c, an image d, an image e and an image f. The image a, the image b, the image c, the image d, the image e and the image f are stitched to form the panoramic video picture. The image a is mapped to the partition A, the image b is mapped to the partition B, the image c is mapped to the partition C, the image d is mapped to the partition D, the image e is mapped to the partition E, and the image f is mapped to the partition F.

As shown in FIG. 3a, the range of the user perspective corresponds to two images, namely, the image c and the image d in the panoramic video picture. After the user perspective is switched, as shown in FIG. 3b, the range of the user perspective corresponds to two images, namely, the image b and the image c in the panoramic video picture.

In an optional implementation, the first bit rate is greater than the second bit rate, the first video area includes an image that is in a panoramic video picture and that corresponds to a range of a user perspective, and the second video area includes any one or more of other images in the panoramic video picture. For example, as shown in FIG. 3a, the first video area includes the image c and the image d, and the images in the first video area are processed at the first bit rate. That is, video data output from the first video area is video data on which compression coding is performed at the first bit rate. The second video area includes any one or more of the image a, the image b, the image e and the image f. The images in the second video area are processed at the second bit rate. That is, video data output from the second video area is video data on which compression coding is performed at the second bit rate.

As an optional implementation, the second bit rate is greater than the first bit rate, the second video area includes an image that is in a panoramic video picture and that corresponds to a range of a user perspective, and the first video area includes any one or more of other images in the panoramic video picture. An image in the first video area is processed at the first bit rate, and an image in the second video area is processed at the second bit rate.

This embodiment of the present application provides a panoramic video processing method. A terminal device receives a partition parameter sent by a display device, then determines a first video area and a second video area in a panoramic video picture according to the partition parameter, processes video data in the first video area at a first bit rate, and processes video data in the second video area at a second bit rate. In this way, an image corresponding to a user observation area is processed at a high bit rate, and an image corresponding to a user non-observation area is processed at a low bit rate, thereby ensuring that timeliness of image transmission between the display device and the terminal device, clarity of a video image viewed by a user, and user experience are improved in a case of a limited channel bandwidth.

In an optional implementation, the processing of the first video area at the first bit rate is specifically: performing compression coding on the video data in the first video area at the first bit rate. The processing of the second video area at the second bit rate is specifically: performing compression coding on the video data in the second video area at the second bit rate.

In an optional implementation, the processing the first video area at the first bit rate is specifically: determining a first group of cameras for photographing the first video area, performing compression coding on video data photographed by the first group of cameras separately at the first bit rate and the second bit rate, and selecting video data on which the compression coding is performed at the first bit rate as video data that needs to be transmitted. The processing the second video area at the second bit rate is specifically: determining a second group of cameras for photographing the second video area, performing compression coding on video data photographed by the second group of cameras separately at the first bit rate and the second bit rate, and selecting video data on which the compression coding is performed at the second bit rate as video data that needs to be transmitted. For example, as shown in FIG. 3a, the first group of cameras includes cameras for photographing the image c and the image d, and video data that is photographed by the first group of cameras and on which the compression coding is performed at the first bit rate is used as video data that needs to be transmitted. The second group of cameras includes cameras for photographing any one or more of the image a, the image b, the image e and the image f, and video data that is photographed by the second group of cameras and on which the compression coding is performed at the second bit rate is used as video data that needs to be transmitted.

The terminal device may send, to the display device in a wireless transmission manner, a video bitstream on which the compression coding is performed or the video data that needs to be transmitted. The wireless transmission manner includes but is not limited to wireless transmission technologies such as Wi-Fi, Bluetooth, ZigBee and mobile data communication. The video bitstream on which the compression coding is performed may alternatively be sent to the display device in a wired transmission manner.

In an optional implementation, the processing the first video area at the first bit rate is specifically: determining a first group of cameras for photographing the first video area, and setting an output bit rate of the first group of cameras to the first bit rate. The processing the second video area at the second bit rate is specifically: determining a second group of cameras for photographing the second video area, and setting an output bit rate of the second group of cameras to the second bit rate. For example, as shown in FIG. 3a, the first group of cameras includes cameras for photographing the image c and the image d, and the output bit rate of the first group of cameras is set to the first bit rate. The second group of cameras includes cameras for photographing any one or more of the image a, the image b, the image e and the image f, and the output bit rate of the second group of cameras is set to the second bit rate.

To further reduce load of a channel bandwidth, assuming that the range of the user perspective corresponds to the first video area in the panoramic video picture, the second group of cameras for photographing the second video area may be turned off, or assuming that the range of the user perspective corresponds to the second video area in the panoramic video picture, the first group of cameras for photographing the first video area may be turned off.

As shown in FIG. 4, an embodiment of the present application provides a panoramic video processing device 40. The processing device 40 includes a parameter receiving module 41, an area determining module 42, a first bit rate processing module 43 and a second bit rate processing module 44.

The parameter receiving module 41 is configured to receive a partition parameter sent by a display device.

The partition parameter is a partition position of a panoramic video picture determined according to a user perspective of the display device.

The area determining module 42 is configured to determine a first video area and a second video area in the panoramic video picture according to the partition parameter.

The first bit rate processing module 43 is configured to process video data in the first video area at a first bit rate.

Specifically, the first bit rate processing module 43 is configured to perform compression coding on the video data in the first video area at the first bit rate; or the first bit rate processing module 43 is configured to: determine a first group of cameras for photographing the first video area, and set an output bit rate of the first group of cameras to the first bit rate.

Alternatively, the first bit rate processing module 43 is configured to perform compression coding on video data in each area at the first bit rate. Further, the first bit rate processing module 43 is further configured to: determine a first group of cameras for photographing the first video area, and use video data that is photographed by the first group of cameras and on which the compression coding is performed at the first bit rate as video data that needs to be transmitted.

The second bit rate processing module 44 is configured to process video data in the second video area at a second bit rate.

Specifically, the second bit rate processing module 44 is configured to perform compression coding on the video data in the second video area at the second bit rate; or the second bit rate processing module 44 is configured to: determine a second group of cameras for photographing the second video area, and set an output bit rate of the second group of cameras to the second bit rate.

Alternatively, the second bit rate processing module 44 is configured to perform compression coding on video data in each area at the second bit rate. Further, the second bit rate processing module 44 is further configured to: determine a second group of cameras for photographing the second video area, and use video data that is photographed by the second group of cameras and on which the compression coding is performed at the second bit rate as video data that needs to be transmitted.

In this embodiment of the present application, the explanations of the parameter receiving module 41, the area determining module 42, the first bit rate processing module 43 and the second bit rate processing module 44, refer to the explanations of step 11, step 12 and step 13 described above.

This embodiment of the present application provides a panoramic video processing device. The parameter receiving module 41 receives a partition parameter sent by a display device. Then, the area determining module 42 determines a first video area and a second video area in a panoramic video picture according to the partition parameter. The first bit rate processing module 43 processes video data in the first video area at a first bit rate. The second bit rate processing module 44 processes video data in the second video area at a second bit rate. In this way, an image corresponding to a user observation area is processed at a high bit rate, and an image corresponding to a user non-observation area is processed at a low bit rate, thereby ensuring that timeliness of image transmission between the display device and a terminal device, clarity of a video image viewed by a user, and user experience are improved in a case of a limited channel bandwidth.

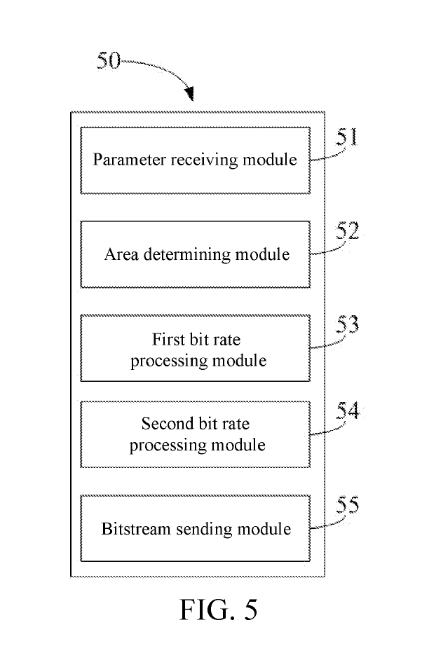

As shown in FIG. 5, another embodiment of the present application provides a panoramic video processing device 50. The processing device 50 includes a parameter receiving module 51, an area determining module 52, a first bit rate processing module 53, a second bit rate processing module 54 and a bitstream sending module 55.

The parameter receiving module 51 is configured to receive a partition parameter sent by a display device.

The area determining module 52 is configured to determine a first video area and a second video area in a panoramic video picture according to the partition parameter.

The first bit rate processing module 53 is configured to perform compression coding on video data in the first video area at a first bit rate.

Alternatively, the first bit rate processing module 53 is configured to perform compression coding on video data in each area at the first bit rate, and the first bit rate processing module 53 is further configured to: determine a first group of cameras for photographing the first video area, and use video data that is photographed by the first group of cameras and on which the compression coding is performed at the first bit rate as video data that needs to be transmitted.

The second bit rate processing module 54 is configured to perform compression coding on video data in the second video area at a second bit rate.

Alternatively, the second bit rate processing module 54 is configured to perform compression coding on video data in each area at the second bit rate. In addition, the second bit rate processing module 54 is further configured to: determine a second group of cameras for photographing the second video area, and use video data that is photographed by the second group of cameras and on which the compression coding is performed at the second bit rate as video data that needs to be transmitted.

The bitstream sending module 55 is configured to send a video bitstream on which the compression coding is performed to the display device in a wireless transmission manner. Alternatively, the bitstream sending module 55 may be substituted for a video data sending module, configured to send, to the display device in a wireless transmission manner, the video data that needs to be transmitted.

In this embodiment of the present application, the explanations of the parameter receiving module 51, the area determining module 52, the first bit rate processing module 53, the second bit rate processing module 54 and the bitstream sending module 55, refer to the explanations of step 11, step 12 and step 13 described above.

This embodiment of the present application provides a panoramic video processing device. The receiving module 51 receives a partition parameter sent by a display device. Then, the area determining module 52 determines a first video area and a second video area in a panoramic video picture according to the partition parameter. The first bit rate processing module 53 performs compression coding on video data in the first video area at a first bit rate. The second bit rate processing module 54 performs compression coding on video data in the second video area at a second bit rate. The bitstream sending module 55 sends a video bitstream on which the compression coding is performed to the display device in a wireless transmission manner. Alternatively, the first bit rate processing module 53 determines to use the video data on which compression coding is performed at the first bit rate in the first video area as video data that needs to be transmitted. The second bit rate processing module 54 uses the video data on which compression coding is performed at the second bit rate in the second video area as video data that needs to be transmitted. The video data sending module sends, to the display device in the wireless transmission manner, the video data that needs to be transmitted. This ensures that timeliness of image transmission between a display device and the terminal device, clarity of a video image viewed by a user, and user experience are improved in a case of a limited channel bandwidth.

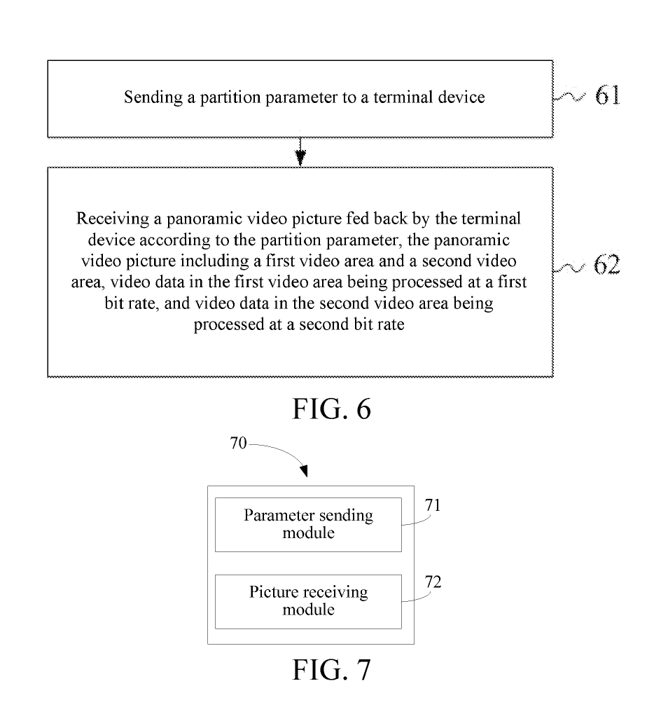

As shown in FIG. 6, an embodiment of the present application provides a panoramic video processing method. The method is performed by a display device. The method includes:

Step 61: sending a partition parameter to a terminal device.

Step 62: receiving a panoramic video picture fed back by the terminal device according to the partition parameter, the panoramic video picture including a first video area and a second video area, video data in the first video area being processed at a first bit rate, and video data in the second video area being processed at a second bit rate.

In this embodiment of the present application, take as an example the terminal device being an aerial vehicle and the display device being a VR head-mounted display device. A panoramic camera module photographs a panoramic video picture. The terminal device feeds back the panoramic video picture to the VR head-mounted display device according to a partition parameter sent by the VR head-mounted display device.

When the VR head-mounted display device is worn by a user, in order that a three-dimensional effect of the panoramic video picture can be viewed, after step 62, the following steps are further included:

building a sphere model in a virtual three-dimensional space; and

mapping the panoramic video picture to a spherical shell of the sphere model, to obtain a spherical video picture shown by the sphere model.

As shown in FIG. 2a, the VR head-mounted display device may build a sphere model 21 in a virtual three-dimensional space, and then map the panoramic video picture to a spherical shell of the sphere model 21, to obtain a spherical video picture shown by the sphere model 21. In this way, a two-dimensional panoramic video picture is simulated into a three-dimensional spherical video picture, for presentation to the user.

Switching of a user perspective can implement the presentation of different areas in the spherical video picture to the user. The implementation of the switching of the user perspective includes but is not limited to the following two manners:

In a first manner, the user wearing the VR head-mounted display device rotates his head, and a gyroscope of the VR head-mounted display device detects the rotation of the user's head and determines an orientation of the user perspective, so as to present an area, to which the user perspective is oriented, in the spherical video picture to the user. For example, an area to which the user perspective is oriented shown in FIG. 2a is switched to an area to which the user perspective is oriented shown in FIG. 2b.

In a second manner, the user wearing the VR head-mounted display device operates a joystick or a button on a remote control, and the VR head-mounted display device can present different areas in the spherical video picture to the user according to swinging by the joystick or triggering by the button. The remote control may communicate with the VR head-mounted display device in a wireless or wired transmission manner.

It should be noted that in the implementation of the switching of the user perspective, the first manner may be adopted, or the second manner may be adopted, or switching between the first manner and the second manner may be adopted, so that the user may select the first manner or the second manner.

In this embodiment of the present application, the spherical shell of the sphere model may be divided into multiple partitions. A quantity of partitions and an area size of each partition may be adaptively adjusted based on a view angle of a display screen of the display device. For example, in FIG. 2a and FIG. 2b, the spherical shell of the sphere model 21 is divided into six partitions. The six partitions include a partition A, a partition B, a partition C, a partition D, a partition E and a partition F. One partition may be used to correspondingly preset a picture of an area photographed by one camera in the panoramic camera module. At a fixed moment, a range of the user perspective can involve one to three partitions, and positions of the partitions involved by the range of the user perspective can be calculated according to an orientation of the user perspective, so that numbers of the involved partitions can be determined.

As an optional implementation, the partition parameter may be positions of partitions of the panoramic video picture determined according to the user perspective of the display device. As shown in FIG. 2a, the range of the user perspective involves two areas, namely, the partition C and the partition D. After the switching of user perspective, as shown in FIG. 2b, the range of the user perspective involves two areas, namely, the partition B and the partition C.

As an optional implementation, the partition parameter includes first identification information and second identification information. After step 62, the following steps are further included:

obtaining, in the spherical video picture, first identification information of an image corresponding to the first video area and second identification information of an image corresponding to the second video area; and

integrating the first identification information and the second identification information into the partition parameter.

In this optional implementation, the image that is in the spherical video picture and that corresponds to the first video area in the panoramic video picture has the first identification information, and the image that is in the spherical video picture and that corresponds to the second video area in the panoramic video picture has the second identification information, so that the first video area and the second video area in the panoramic video picture can be determined by using the first identification information and the second identification information.

The first identification information and the second identification information are integrated into the partition parameter.

FIG. 3a is a schematic diagram of images in the panoramic video picture that correspond to the range of the user perspective in FIG. 2a. FIG. 3b is a schematic diagram of images in the panoramic video picture that correspond to the user perspective in FIG. 2b.

In this embodiment of the present application, the images in the panoramic video picture include an image a, an image b, an image c, an image d, an image e and an image f. The image a, the image b, the image c, the image d, the image e and the image f are stitched to form the panoramic video picture. The image a is mapped to the partition A, the image b is mapped to the partition B, the image c is mapped to the partition C, the image d is mapped to the partition D, the image e is mapped to the partition E, and the image f is mapped to the partition F.

Further, a step of detecting whether a partition position of a panoramic video picture corresponding to the user perspective changes is further included. If the partition position changes, the partition parameter is resent to the terminal device.

As shown in FIG. 3a, the range of the user perspective corresponds to two images, namely, the image c and the image d in the panoramic video picture. After the user perspective is switched, as shown in FIG. 3b, the range of the user perspective corresponds to two images, namely, the image b and the image c in the panoramic video picture. This is equivalent to changes of the first video area the second video area. In this case, the first identification information and the second identification information included in the partition parameter change accordingly. After the obtaining of a new partition parameter from integration of the new first identification information and the new second identification information, the new partition parameter is resent to the terminal device.

As an optional implementation, the first bit rate is greater than the second bit rate, the first video area includes an image that is in a panoramic video picture and that corresponds to a range of a user perspective, and the second video area includes any one or more of other images in the panoramic video picture. For example, as shown in FIG. 3a, the first video area includes an image c and an image d, and the images in the first video area are processed at the first bit rate; the second video area includes any one or more of an image a, an image b, an image e and an image f, and the images in the second video area are processed at the second bit rate.

As an optional implementation, the second bit rate is greater than the first bit rate, the second video area includes an image that is in a panoramic video picture and that corresponds to a range of a user perspective, and the first video area includes any one or more of other images in the panoramic video picture. An image in the first video area is processed at the first bit rate, and an image in the second video area is processed at the second bit rate.

After step 62, the following steps are further included:

displaying the image corresponding to the first video area or the image corresponding to the second video area in the spherical video picture.

This embodiment of the present application provides a panoramic video processing method. A partition parameter is sent to a terminal device, and a panoramic video picture fed back by the terminal device according to the partition parameter is received. The panoramic video picture includes a first video area and a second video area, video data in the first video area is processed at a first bit rate, and video data in the second video area is processed at a second bit rate. This ensures that timeliness of image transmission between a display device and the terminal device, clarity of a video image viewed by a user, and user experience are improved in a case of a limited channel bandwidth.

As shown in FIG. 7, an embodiment of the present application provides a panoramic video processing device 70. The processing device 70 includes a parameter sending module 71 and a picture receiving module 72.

The parameter sending module 71 is configured to send a partition parameter to a terminal device.

The picture receiving module 72 is configured to receive a panoramic video picture fed back by the terminal device according to the partition parameter, the panoramic video picture including a first video area and a second video area, video data in the first video area being processed at a first bit rate, and video data in the second video area being processed at a second bit rate.

In this embodiment of the present application, the explanations of the parameter sending module 71 and the picture receiving module 72, refer to the explanations of step 61 and step 62.

This embodiment of the present application provides a panoramic video processing device. A parameter sending module sends a partition parameter to a terminal device. A picture receiving module receives a panoramic video picture fed back by the terminal device according to the partition parameter. The panoramic video picture includes a first video area and a second video area, video data in the first video area is processed at a first bit rate, and video data in the second video area is processed at a second bit rate. This ensures that timeliness of image transmission between a display device and the terminal device, clarity of a video image viewed by a user, and user experience are improved in a case of a limited channel bandwidth.

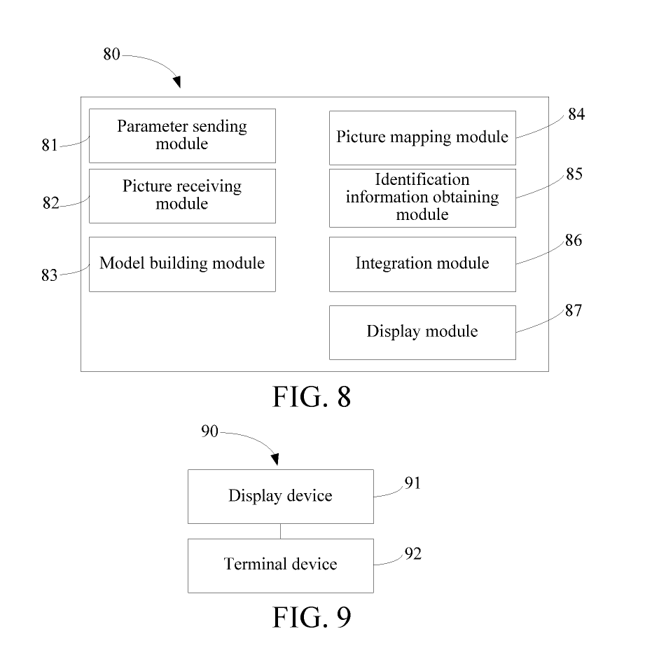

As shown in FIG. 8, another embodiment of the present application provides a panoramic video processing device 80. The processing device 80 includes a parameter sending module 81, a picture receiving module 82, a model building module 83, a picture mapping module 84, an identification information obtaining module 85, an integration module 86 and a display module 87.

The parameter sending module 81 is configured to send a partition parameter to a terminal device.

The picture receiving module 82 is configured to receive a panoramic video picture fed back by the terminal device according to the partition parameter, the panoramic video picture including a first video area and a second video area, video data in the first video area being processed at a first bit rate, and video data in the second video area being processed at a second bit rate.

The model building module 83 is configured to build a sphere model in a virtual three-dimensional space.

The picture mapping module 84 is configured to map the panoramic video picture to a spherical shell of the sphere model, to obtain a spherical video picture shown by the sphere model.

The identification information obtaining module 85 is configured to obtain, in the spherical video picture, first identification information of an image corresponding to the first video area and second identification information of an image corresponding to the second video area.

The integration module 86 is configured to integrate the first identification information and the second identification information into the partition parameter.

It may be understood that in another embodiment, a detection module is further included, configured to detect whether a partition position of a panoramic video picture corresponding to a user perspective changes, and if yes, reseed the partition parameter to the terminal device by using the parameter sending module 81.

As shown in FIG. 2a, a range of the user perspective relates to two areas, namely, a partition C and a partition D. After the user perspective is switched, as shown in FIG. 2b, the range of the user perspective is switched to two areas, namely, a partition B and the partition C. That is, changes happen to the first video area and the second video area. In this way, the first identification information and the second identification information included in the partition parameter accordingly change. After the integration module 86 integrates the new first identification information and the new second identification information into a new partition parameter, the sending module 81 sends the partition parameter to the terminal device.

The display module 87 is configured to display the image corresponding to the first video area or the image corresponding to the second video area in the spherical video picture.

In this embodiment of the present application, the explanations of the parameter sending module 81, the picture receiving module 82, the model building module 83, the picture mapping module 84, the identification information obtaining module 85, the integration module 86, and the display module 87, refer to the explanations of step 61 and step 62 described above.

As shown in FIG. 9, an embodiment of the present application provides a panoramic video processing system 90. The system includes a display device 91 and a terminal device 92. The terminal device may be an aerial vehicle, a camera, a mobile phone, a tablet computer, or the like. The display device may be a VR head-mounted display device, a television, a projection device, or the like.

The display device 91 is configured to send a partition parameter to the terminal device.

As an optional implementation, the partition parameter may be a partition position of a panoramic video picture determined according to a user perspective of the display device.

As an optional implementation, the partition parameter includes first identification information and second identification information, A step of determining the partition parameter specifically includes:

obtaining, in a spherical video picture, first identification information of an image corresponding to a first video area and second identification information of an image corresponding to a second video area; and

integrating the first identification information and the second identification information into the partition parameter.

The terminal device 92 is configured to: determine a first video area and a second video area in a panoramic video picture according to the partition parameter, process video data in the first video area at a first bit rate, and process video data in the second video area at a second bit rate.

In an optional implementation, the first bit rate is greater than the second bit rate, the first video area includes an image that is in a panoramic video picture and that corresponds to a range of a user perspective, and the second video area includes any one or more of other images in the panoramic video picture. For example, as shown in FIG. 3a, the first video area includes an image c and an image d, and the images in the first video area are processed at the first bit rate; the second video area includes any one or more of an image a, an image b, an image e and an image f, and the images in the second video area are processed at the second bit rate.

In an optional implementation, the second bit rate is greater than the first bit rate, the second video area includes an image that is in a panoramic video picture and that corresponds to a range of a user perspective, and the first video area includes any one or more of other images in the panoramic video picture. An image in the first video area is processed at the first bit rate, and an image in the second video area is processed at the second bit rate.

This embodiment of the present application provides a panoramic video processing system. A display device sends a partition parameter to a terminal device. The terminal device determines a first video area and a second video area in a panoramic video picture according to the partition parameter, processes video data in the first video area at a first bit rate, and processes video data in the second video area at a second bit rate. This ensures that timeliness of image transmission between the display device and the terminal device, clarity of a video image viewed by a user, and user experience are improved in a case of a limited channel bandwidth.

A person of ordinary skill in the art may understand that all or some of the steps of the methods in the embodiments may be implemented by a program instructing relevant hardware. The program may be stored in a computer readable storage medium, and the storage medium may be a read-only memory (ROM), a random access memory (RAM), a magnetic disk, an optical disk, and the like.

The foregoing descriptions are merely preferred embodiments of the present application, and are not intended to limit the present application. Any modification, equivalent replacement, and improvement made within the spirit and principle of the present application shall fall within the protection scope of the present application.

What is claimed is:

1. A panoramic video processing method, comprising:
receiving a partition parameter sent by a display device;
determining a first video area and a second video area in a panoramic video picture according to the partition parameter; and
processing video data in the first video area at a first bit rate, and processing video data in the second video area at a second bit rate.

2. The panoramic video processing method according to claim 1, wherein the partition parameter is a partition position of a panoramic video picture determined according to a user perspective of the display device.

3. The panoramic video processing method according to claim 1, wherein the processing video data in the first video area at the first bit rate, and processing video data in the second video area at the second bit rate is specifically:
performing compression coding on the video data in the first video area at the first bit rate; and
performing compression coding on the video data in the second video area at the second bit rate.

4. The panoramic video processing method according to claim 3, further comprising:
sending a video bitstream on which the compression coding is performed to the display device in a wireless transmission manner.

5. The panoramic video processing method according to claim 2, wherein the processing video data in the first video area at the first bit rate, and processing video data in the second video area at the second bit rate is specifically:
performing compression coding on the video data in the first video area at the first bit rate; and
performing compression coding on the video data in the second video area at the second bit rate.

6. The panoramic video processing method according to claim 1, wherein the processing video data in the first video area at the first bit rate, and processing video data in the second video area at the second bit rate is specifically:
determining a first group of cameras for photographing the first video area, and setting an output bit rate of the first group of cameras to the first bit rate; and
determining a second group of cameras for photographing the second video area, and setting an output bit rate of the second group of cameras to the second bit rate.

7. The panoramic video processing method according to claim 1, wherein the processing video data in the first video area at the first bit rate, and processing video data in the second video area at the second bit rate is specifically:
determining a first group of cameras for photographing the first video area, performing compression coding on video data photographed by the first group of cameras separately at the first bit rate and the second bit rate, and selecting video data on which the compression coding is performed at the first bit rate as video data that needs to be transmitted; and
determining a second group of cameras for photographing the second video area, performing compression coding on video data photographed by the second group of cameras separately at the first bit rate and the second bit rate, and selecting video data on which the compression coding is performed at the second bit rate as video data that needs to be transmitted.

8. The panoramic video processing method according to claim 7, further comprising:
sending, to the display device in a wireless transmission manner, the video data that needs to be transmitted.

9. The panoramic video processing method according to claim 2, wherein the processing video data in the first video area at the first bit rate, and processing video data in the second video area at the second bit rate is specifically:
determining a first group of cameras for photographing the first video area, performing compression coding on video data photographed by the first group of cameras separately at the first bit rate and the second bit rate, and selecting video data on which the compression coding is performed at the first bit rate as video data that needs to be transmitted; and
determining a second group of cameras for photographing the second video area, performing compression coding on video data photographed by the second group of cameras separately at the first bit rate and the second bit rate, and selecting video data on which the compression coding is performed at the second bit rate as video data that needs to be transmitted.

10. A panoramic video processing method, wherein the method comprises:
sending a partition parameter to a terminal device; and
receiving a panoramic video picture fed back by the terminal device according to the partition parameter, the panoramic video picture comprising a first video area and a second video area, video data in the first video area being processed at a first bit rate, and video data in the second video area being processed at a second bit rate.

11. The method according to claim 10, wherein after the step of receiving the panoramic video picture fed back by the terminal device according to the partition parameter, the method further comprises:
building a sphere model in a virtual three-dimensional space; and
mapping the panoramic video picture to a spherical shell of the sphere model, to obtain a spherical video picture shown by the sphere model.

12. The method according to claim 11, wherein the partition parameter is a partition position of a panoramic video picture determined according to a user perspective.

13. The method according to claim 11, wherein after the step of mapping the panoramic video picture to a spherical shell of the sphere model to obtain a spherical video picture shown by the sphere model, the method further comprises:
obtaining, in the spherical video picture, first identification information of an image corresponding to the first video area and second identification information of an image corresponding to the second video area; and
integrating the first identification information and the second identification information into the partition parameter.

14. The method according to claim 11, wherein after the step of receiving the panoramic video picture fed back by the terminal device according to the partition parameter, the method further comprises:
displaying the image corresponding to the first video area or the image corresponding to the second video area in the spherical video picture.

15. The method according to claim 11, wherein the method further comprises:
detecting whether a partition position of a panoramic video picture corresponding to the user perspective changes, and if yes, resending the partition parameter to the terminal device.

16. A panoramic video processing system, wherein the system comprises:
a display device, configured to send a partition parameter to a terminal device; and
a terminal device, configured to: determine a first video area and a second video area in a panoramic video picture according to the partition parameter, process video data in the first video area at a first bit rate, and process video data in the second video area at a second bit rate.

17. The panoramic video processing system according to claim 16, wherein the partition parameter is a partition position of a panoramic video picture determined according to a user perspective of the display device.

18. The panoramic video processing system according to claim 16, wherein the terminal device is further configured to:
perform compression coding on the video data in the first video area at the first bit rate; and
perform compression coding on the video data in the second video area at the second bit rate.

19. The panoramic video processing system according to claim 18, wherein the terminal device is further configured to:
send a video bitstream on which the compression coding is performed to the display device in a wireless transmission manner.

20. The panoramic video processing system according to claim 16, wherein the terminal device is further configured to:
determine a first group of cameras for photographing the first video area, and setting an output bit rate of the first group of cameras to the first bit rate; and
determine a second group of cameras fir photographing the second video area, and setting an output bit rate of the second group of cameras to the second bit rate.
